(19) United States
(12) Patent Application Publication
(10) Pub. No.: US 2014/0006921 A1
(43) Pub. Date: Jan. 2, 2014

(54) ANNOTATING DIGITAL DOCUMENTS USING TEMPORAL AND POSITIONAL MODES

(71) Applicant: Infosys Limited, Bangalore (IN)

(72) Inventors: Ashok Gopinath, Bangalore (IN); Anurag Singh, Bangalore (IN); Arun Menon, Bangalore (IN)

(21) Appl. No.: 13/915,577

(22) Filed: Jun. 11, 2013

(30) Foreign Application Priority Data
Jun. 29, 2012 (IN) 2609/CHE/2012

(51) Int. Cl. G06F 17/24

(52) U.S. Cl. CPC G06F 17/241
USPC 715/230

(57) ABSTRACT

Digital documents can be annotated using a variety of techniques. Document image pages can be created from digital documents. Annotations can be created using the document image pages. Annotation content (such as individual annotation elements, including text, audio, video, picture, and/or drawing annotation elements) can be generated from the annotations. Annotation content can be supported in a temporal annotation mode and in a positional annotation mode. Annotation content and document image pages can be stored separately. Annotation content and document image pages can be used (e.g., downloaded, viewed, played, edited, etc.) by one or more client devices.

### BACKGROUND

With the ever increasing number of documents available to users, the ability to collaborate using documents is becoming more important. Collaboration can be used to share, explain, or comment on documents among a community of users.

Collaboration and document sharing solutions exist, such as solutions that allow users to annotate and share documents. However, these solutions have a number of limitations. For example, some solutions require users to work on documents in a specific format, such as a particular word processing format. If a user does not have software installed that can use the specific format, then the user cannot participate in the collaboration. As another example, some solutions provide for collaboration in a shared workspace. The results of the collaboration can be saved and viewed later as a static view. However, modifying or editing the collaboration at a later time, including modification of individual collaboration elements, may not be possible.

Therefore, there exists ample opportunity for improvement in technologies related to annotating documents.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for annotating digital documents. For example, document image pages can be created from digital documents. Annotations can be created using the document image pages. Annotation content (such as individual annotation elements, including text, audio, video, picture, and/or drawing annotation elements) can be generated from the annotations (e.g., using an annotation format). Annotation content can be supported in a temporal annotation mode and in a positional annotation mode. Annotation content and document image pages can be stored separately (independently). Annotation content and document image pages can be used (e.g., downloaded, viewed, played, edited, etc.) by one or more client devices (e.g., simultaneously and in real-time).

For example, a method can be provided for annotating digital documents. The method comprises receiving a digital document, converting pages of the received digital document into corresponding document image pages, receiving annotation content for the document image pages, where the annotation content is supported in a temporal annotation mode and in a positional annotation mode, and storing the document image pages and the annotation content, where the document image pages and the annotation content are stored separately, and where the document image pages are available for display separately from the annotation content.

The method can be implemented by one or more computer servers (e.g., as part of a server environment or cloud computing environment). The method can provide annotation services to one or more client devices. For example, the digital document can be received from a client device and the digital document images can be sent to the client device for annotation. The annotation content can be received from the client device. Stored annotation content and document image pages can be provided to one or more client devices for displaying and/or editing (e.g., creating or editing annotations).

As another example, a method is provided for annotating digital documents. The method comprises obtaining a plurality of document image pages, where the plurality of document image pages correspond to pages of a digital document that have been converted into the plurality of document image pages, receiving annotations of the plurality of document image pages, where the annotations are supported in a temporal annotation mode and in a positional annotation mode, generating annotation content from the received annotations, and providing the annotation content for storage, where the annotation content is stored independent of the document image pages, and where the document image pages are available for display separately from the annotation content.

The method can be implemented by a computing device (e.g., a client computing device). For example, the client device can receive the document image pages (e.g., from a local component or from remote servers), the client device can receive the annotations from a user and generate the annotation content, and the client device can provide the annotation content for storage (e.g., local storage or remote storage provided by computer servers).

As another example, systems comprising processing units and memory can be provided for performing operations described herein. For example, a system can be provided for annotating digital documents (e.g., comprising computer-readable storage media storing computer-executable instructions for causing the system to perform operations for annotating digital documents).

As described herein, a variety of other features and advantages can be incorporated into the technologies as desired.

### BRIEF DESCRIPTION OF THE DRAWINGS

FIG. 1 is a block diagram of an exemplary annotation environment.

FIG. 2 is a block diagram of an exemplary annotation environment, including a document view generator and a document view manager.

FIG. 3 is a flowchart of an exemplary method for annotating digital documents.

FIG. 4 is a flowchart of an exemplary method for annotating digital documents.

FIG. 5 is a diagram showing example annotation content displayed on top of document image pages using a positional annotation mode.

FIG. 6 is a diagram showing example annotation content displayed on top of document image pages using a temporal annotation mode.

FIG. 7 is a diagram of an exemplary computing system in which some described embodiments can be implemented.

FIG. 8 is an exemplary mobile device that can be used in conjunction with the technologies described herein.

FIG. 9 is an exemplary cloud computing environment that can be used in conjunction with the technologies described herein.

### DETAILED DESCRIPTION

### Example 1

### Exemplary Overview

The following description is directed to techniques and solutions for annotating digital documents. For example, digital documents can be converted into digital document images (converted from a document format to an image format). Conversion of digital documents can comprise converting each page of the digital document into a corresponding document image page.

Annotations can be created on top of the digital document images. For example, the annotations can include text annotations, audio annotations, video annotations, drawing annotations, picture annotations, and other types of annotations. Annotation content can be generated from the annotations (e.g., annotation content defining the annotation and related information, such as position and timing information). Annotation content can be defined using an annotation format.

Annotations, and annotation content, can be supported in a temporal annotation mode and a positional annotation mode. A temporal annotation mode can use a timeline (e.g., using an audio or video file), and annotation elements and other events can be tied to the timeline. A positional annotation mode can define location and timing information for annotation elements.

Annotation content and associated document image pages can be stored and retrieved separately (independently). For example, original document image pages can be accessed and utilized (e.g., separate from any associated annotation content). In this manner, annotation content from multiple users can be associated with a document image page, while providing for independent access to the document image page (without any associated annotation content), independent access to any or all of the annotation content (e.g., annotation content can be accessed on a per-element basis or a per-user basis), and independent access to combinations (e.g., access to the document image page with annotation content for only one or more specific users).

Furthermore, access (e.g., downloading or retrieval) to document image pages and associated annotation content can be performed efficiently (e.g., accessed as needed or on-demand). For example, a user accessing a set of document image pages and their associated annotation content can download a first document image page along with the annotation content for the elements used on the first document image page (e.g., a subset of the annotation content for the set of document image pages). The use can use (e.g., view, modify, etc.) the first document image page and associated annotation content. When the user wants to view the next page in the set of document image pages, the user can download the second document image page along with the annotation content for the elements used on the second document image page. In this manner, the user only has to access or download the content required for the current document image page. Alternatively, a full package of document image pages and associated annotation content can be accessed at once (e.g., for use in an offline mode, or when bandwidth is not a concern).

In addition, access (e.g., downloading or retrieval) of document image pages and associated annotation content can be tailored to capabilities (e.g., display, network, computing resource, memory, or other capabilities) of a user's computing device. For example, the resolution and/or size of document image pages can be modified to account for capabilities of a specific client device (e.g., screen resolution).

Document image pages and annotations can be shared among a group of users. For example, multiple users can participate in a shared collaborative annotation environment where the users can view and modify annotation content created by other users (e.g., according to permissions or policies). Annotations created in this manner can be saved and retrieved later (e.g., for viewing and/or editing). In this manner, real-time collaboration using annotations (e.g., in a temporal annotation mode and a positional annotation mode) can be performed.

Annotations can comprise events such as pan, zoom, page turns, and the like. Annotations also include dynamic annotations. Dynamic annotations can comprise drawing annotations (e.g., by capturing freehand drawings (e.g., using a touch screen)). Dynamic annotations can also comprise annotations that are timed (e.g., displayed on a page a number of seconds after the page is displayed, or displayed on a page for a specific duration).

### Example 2

### Exemplary Digital Documents

In any of the examples herein, a digital document refers to any type of document in a digital format. For example, a digital document can be a text document (e.g., a word processing document), a web page or collection of web pages, a multimedia document (e.g., a document comprising text, images, and/or other multimedia content), or another type of document.

A digital document can comprise one or more pages (e.g., the document can be divided into one or more pages for viewing or printing). For example, a page can correspond to a printed page (e.g., a printed page of a text document), or to another type of page (e.g., a web page, which may print as one or more printed pages).

A digital document can be in any type of document format. For example, digital document formats include word processing formats (such as Microsoft® Word and OpenDocument formats), portable document formats (such as Adobe® Portable Document Format (PDF)), markup formats (such as HyperText Markup Language (HTML)), etc.

A digital document can be converted into a document image (into an image format).

Converting a digital document into a document image (e.g., into an image format such as a Joint Photographic Experts Group (JPEG) image, a Tagged Image File Format (TIFF) image, a Portable Network Graphics (PNG) image, or another type of image format) allows the document image to be utilized on devices that may or may not have the ability to work with the document in its document format. For example, a document in Word format can be converted into a document image (e.g., one or more JPEG images representing the Word document content). The document image can then be used on a computing device (e.g., a mobile device, such as a tablet computer or smart phone) that does not have an application for viewing Word documents, but does have applications for viewing images (e.g., JPEG images).

In some implementations, pages of a digital document are converted into corresponding document image pages. For example, a Word document may have four pages. Each of the four pages of the Word document can be converted into its respective document image page (e.g., a JPEG image). The result of the conversion would be four document image pages (e.g., four JPEG images), each document image page corresponding to one of the original document pages.

### Example 3

### Exemplary Annotation Content

In any of the examples herein, annotation content comprises any type of content that can be used to annotate a digital document. For example, annotation content can be text content, audio content, video content, picture or image content, drawing content, or combinations.

Annotation content can comprise annotation elements. For example, an element of annotation content can be a specific text annotation element or a specific video clip annotation element. Annotation content can also comprise information related to, or describing, a specific annotation element. For example, annotation content can comprise a specific text annotation element with its associated position (e.g., an X, Y position) for displaying the text annotation on a specific document image page. Annotation content can also comprise annotation mode information (e.g., temporal or positional mode), document image page identification information (e.g., identification of specific document image pages that are associated with specific annotation elements), user information (e.g., identification of specific users associated with specific annotation elements and/or document image pages), and other annotation-related information.

Annotation content can be generated from user annotations (e.g., actions taken by users to annotate document images). For example, a user can annotate a document image by creating or editing text annotations, video annotations, audio annotations, or other types of annotations. Annotation content can be generated from the annotations. For example, in response to a user entering a text annotation, annotation content can be generated comprising the text content of the annotation as well as position, timing information, document image page, and/or user information.

Annotations can be performed without altering the underlying document image. For example, annotations can be added on top of a document image page (e.g., on a separate “layer”).

### Example 4

### Exemplary Positional Annotation Mode

In any of the examples herein, a positional annotation mode can be used for annotating documents. In a positional annotation mode, the document (e.g., the document image pages) represents the main structure, and the annotation content is displayed relative to the document.

Using positional annotation mode, annotation content can be displayed at specific locations on a document (e.g., at specific X, Y coordinates of a specific document image page). For example, a specific text annotation can be displayed at a specific location on the left-hand side of a document image page while a specific video annotation can be displayed at a specific location on the right-hand side of the document image page.

Using positional annotation mode, multiple document image pages can be displayed. For example, a first document image page can be displayed with its associated annotation content (e.g., multiple annotation elements, such as text, video, audio, and/or picture annotation elements) at specific locations on (e.g., overlaid on top of) the first document image page. A second document image page (e.g., a second page of a multi-page document) can be displayed with its associated annotation content. Switching from one page to another can be performed (e.g., by a user selecting the next or previous page).

Positional annotation information can be stored in an annotation format. For example, positional annotation information can be stored for each of a plurality of annotation elements. The positional annotation information can include, for example, coordinates at which the annotation element is to be displayed (e.g., X, Y coordinates) and an identifier of a document image page.

### Example 5

### Exemplary Temporal Annotation Mode

In any of the examples herein, a temporal annotation mode can be used for annotating documents. In a temporal annotation mode, a timeline (e.g., represented by audio, video, or audio/video content) represents the main structure, and the annotation content (e.g., some or all of the annotation content) can be linked to, or associated with, the timeline.

Using temporal annotation mode, a timeline is used to control playback or display of a sequence of one or more document images. For example, a video file can be selected and a sequence of multiple document image pages can be displayed with their associated annotation content. Timing of events, such as display and transition between document image pages, can be controlled by the video timeline. Other types of events can also be tied to the video timeline, such as display of other annotation elements (e.g., text annotation elements, video annotation elements, etc.).

Using temporal annotation mode can provide a rich experience for a user that desires a narration approach to annotations. For example, a video or audio presentation can be created and tied to a multi-page financial report document. The video or audio presentation can play while document image pages of the financial report are displayed. During the video and/or audio playback, other annotation content can be displayed. For example, the presentation can discuss a specific graph or chart, and a drawing annotation element can be displayed to draw a circle around the specific graph or chart on the displayed document image page. As another example, a text annotation element can be displayed to provide additional detail while the presentation discusses a specific financial value.

### Example 6

### Exemplary Dynamic Annotations

In any of the examples herein, dynamic annotations refer to annotations that capture a real-time event or that have a timing or duration. For example, a dynamic annotation can be a user drawing a circle or arrow to highlight a specific portion of a document image page. The drawing can be captured as a dynamic annotation element, such that when the drawing annotation element is displayed later, the drawing action is repeated (e.g., a circle or arrow is drawn as it was originally), instead of merely capturing a completed drawing as a static image.

Dynamic annotations can also be used to time display of an element. For example, if a new document image page is displayed, a specific text annotation element can be displayed as a dynamic annotation at a specific time (e.g., a number of seconds) after display of the document image page. Similarly, dynamic annotations can also be used to indicate duration. For example, a specific text annotation element can be displayed for a specific duration (e.g., a number of seconds) and then removed.

### Example 7

### Exemplary Storing Annotation Content

In any of the examples herein, annotation content can be stored separately (e.g., independent of) document images. For example, annotation content can be stored in separate files or a separate data store from the document images. Furthermore, annotation content can be stored in a text file format (e.g., as XML documents), while the document images can be stored in an image file format (e.g., as JPEG or PNG image files).

Because the original document images are retained when annotation content is generated, annotation content can be displayed, edited, and/or stored separately from the document images. Furthermore, annotation content can be searched independent of document images.

Annotation content and associated document images can be stored at a central location. For example, a server environment (e.g., part of a cloud computing service) can store annotation content and associated document images and provide them for access by multiple client devices.

### Example 8

### Exemplary Document View Generator

In any of the examples herein, a document view generator is a component (e.g., a software and/or hardware component) that is used to generate document images. For example, a document view generator can receive a digital document (e.g., received from a client device, such as a computer, tablet, or smart phone) in a document format and generate document images in an image format. In some implementations, the document view generator generates a document image page corresponding to each page of the digital document. The document view generator can also send generated document images (e.g., document image pages) to a client device (e.g., for use by the client device in creating, editing, or viewing annotation content along with the document images).

A document view generator can generate document images according to capabilities of a client device. For example, the document view generator can generate document images with a resolution matching the capabilities of a client device (e.g., a client device with a lower resolution screen can receive a document image page with a lower resolution). In addition, the document images can be generated in different image formats. For example, a client device with lower bandwidth can receive document images in highly compressed JPEG format. Similarly, a client device with limited processing capacity can receive document images in an image format that requires less processing power to decode.

In a specific implementation, the document view generator is located in a server environment (e.g., runs on one or more computer servers, or as part of a cloud computing service). By providing the document view generator in a server environment, multiple client devices can be supported. For example, the multiple client devices (e.g., desktop computers, laptop computers, mobile devices, tablet computers, smart phones, or other computing devices) can use the document view generator to convert documents into document image pages.

In another implementation, the document view generator is located on the client device (e.g., instead of, or in addition to, a server environment hosted document view generator). By hosting the document view generator on the client device, the client device can generate document images from documents locally, without having to communicate with the server environment (e.g., if the client is in an offline mode or has limited network connectivity or bandwidth).

### Example 9

### Exemplary Document View Manager

In any of the examples herein, a document view manager is a component (e.g., a software and/or hardware component) that is used to view, create, edit, modify, and/or play annotations. For example, a document view manager can receive document image pages (e.g., generated by a document view generator) and allow a user to view and browse the document image pages (e.g., scroll through pages, zoom in/out, flip pages, etc.).

The document view manager can provide an environment for a user to create and edit annotations (e.g., text, audio, video, picture, and other types of annotations). For example, the document view manager can allow a user to select a specific document image page and compose annotations on top of the document image page (e.g., at a specific location or using a timeline).

In some implementations, the document view manager supports one or more of the following features (e.g., by performing actions according to commands received from a user):
Allows the user to select one or more document images from a local or remote file store.
Allows the user to specify whether annotations for the selected document images will use a positional annotation mode or a temporal annotation mode. In positional annotation mode, the document images will be the foundation over which the annotations are presented. In temporal annotation mode, a timeline (e.g., an audio or video file) will be the foundation, and document browsing and annotations can be tied to the timeline.
Allows the user to specify an audio or video file to be used as the timeline if the temporal annotation mode is selected.
Allows the user to record or capture audio and/or video to be used as the timeline if the temporal annotation mode is selected.

In some implementations, the document view manager supports one or more of the following features for creating annotations using a positional annotation mode (e.g., by performing actions according to commands received from a user):
Allows the user to select media files (e.g., audio, video, audio/video, and multimedia content) and position them with respect to a document image (e.g., positioned at a specific location of a specific document image page).
Allows the user to draw or scribble (e.g., with the user's finger, stylus, or other drawing device, such as on a touch-screen of the user's computing device) drawing content, such as shapes or arbitrary content, on a document image (e.g., at a specific position on a document image page).
Allows the user to create text, or rich text, annotations on a document image (e.g., at a specific position on the document image page).
Allows the user to specify timing information for annotation elements, including display time (e.g., display a text annotation element a number of seconds after a specific document image page is displayed) and duration (e.g., display a text annotation element for a specific amount of time and then remove it from display).
Allows the user to capture audio and/or video (e.g., via a camera and/or microphone of user's computing device) and create audio and/or video annotations for a document image (e.g., positioned at a specific location on the document image).

In some implementations, the document view manager supports one or more of the following features for creating annotations using a temporal annotation mode (e.g., by performing actions according to commands received from a user):
Allows the user to create all of the above-described types of annotations and annotation content for the positional annotation mode.
Allows the user to create events, such as document page transitions, zooming in/out, page up/down, pan, skip, scroll, etc.
Allows the user to tie various events and annotations to the timeline associated with the document images (e.g., timing of display, duration, etc.).

In some implementations, the document view manager includes a player component. The player component can be responsible for viewing or playing annotation content. For example, the player component can support one or more of the following operations:
Retrieve document image pages, associated annotation content, and related information (e.g., from a document store associated with a server environment). The document image pages, associated annotation content, and related information (e.g., separate audio or video files, such as those used for annotation elements and/or for a temporal annotation mode) can be retrieved when needed (e.g., only the currently needed page and content). The annotation content can be received in an annotation format (e.g., an XML format).
Display document image pages and associated annotation content according to positional information when the annotation content uses a positional annotation mode.
Display document image pages and associated annotation content according to temporal information when the annotation content uses a temporal annotation mode.

### Example 10

### Exemplary Document Store

In any of the examples herein, a document store can be used to store documents, document images, annotation content, and/or related information. The document store can be implemented as part of a server environment (e.g., a data store associated with one or more computer servers or as part of a cloud computing service). The document store can store annotation content separately from document images.

The document store can provide document images, annotation content, and related information for use by client devices and servers in providing annotation services (e.g., using a document image viewer and/or a document view manager). For example, document image pages and associated annotation content can be provided to multiple client devices for viewing and/or editing.

### Example 11

### Exemplary Annotation Format

In any of the examples herein, annotations can be stored in, defined by, or referenced by an annotation format. For example, the annotation format can define various annotation elements and their attributes, link to annotation content files (e.g., text, audio, and/or video files), and define attributes related to document images (e.g., temporal and/or positional mode information).

An annotation format can include annotation information related to a specific set of document images (e.g., related to a set of document image pages). The annotation format can define the annotation elements associated with the specific document images.

An annotation format can be used when viewing or editing annotations. For example, annotation content in an annotation format can be downloaded from a server environment to a client device along with document image pages. The client device can use the annotation format to display the document image pages with associated annotation elements as defined in the format.

Below is an example Extensible Markup Language (XML) annotation format. The below XML annotation format is merely one example format, and other formats can be used.

```
<annotation type=“temporal_base|positional_base” doc_file=
“path_of_base_doc” media_file=“path_of_base_file”>
  <page number=“pg_no” show_at=“n_seconds”>
    <annotations>
      <annotation id=“id_no”
type=“user_image|stock_icon|audio|video|rich_text|drawing”
user_id=“annotation_provideer_id” color_id=“annotation_color”>
        <timing show_at=“n_seconds” show_for=“n_seconds”/>
        <position start_x=“x_position” start_y=“y_position”
trail_data=“path_of_movement_file”/>
      </annotation>
      <annotation>
        // Additional annotations . . .
      </annotation>
    <annotations>
    <events>
      <event type=“scroll|zoom_in|zoom_out|page”
vector=“vector_value_of_evene”>
        <timing show_at=“n_seconds” show_for=“n_seconds”/>
      </event>
      <event>
        // Additional events . . .
      </event>
    </events>
  </page>
  <page>
    // Additional pages . . .
  </page>
</annotation>
```

### Example 12

### Exemplary Annotation Environment

In any of the examples herein, an annotation environment can be provided for creating, editing, storing, and viewing annotations. The annotation environment can comprise a server environment and a plurality of client devices.

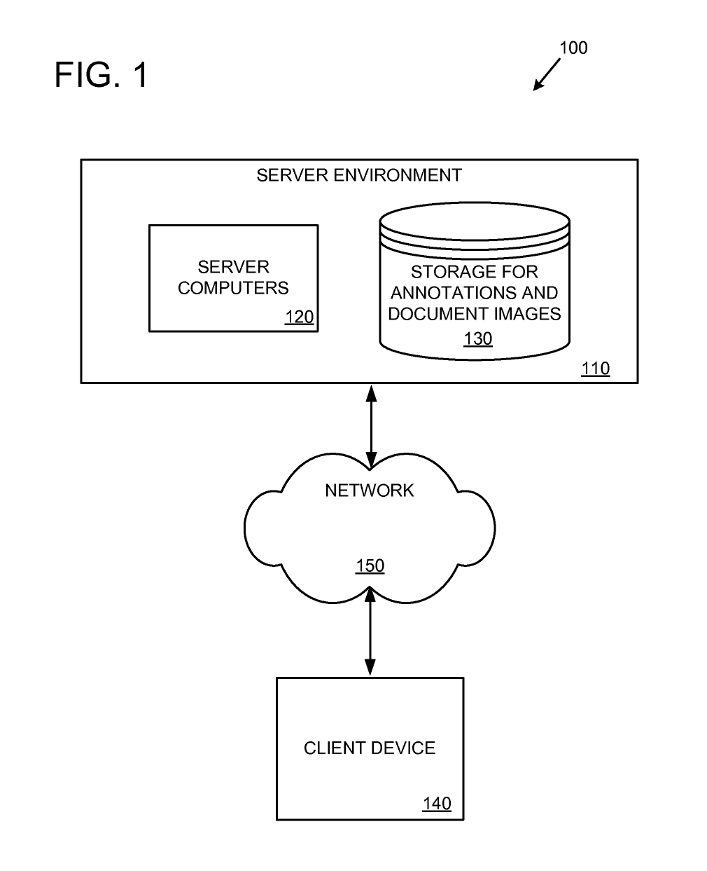

FIG. 1 is a diagram depicting an example annotation environment 100. The example annotation environment 100 includes a server environment 110 that comprises computer servers 120 and storage for annotations and document images 130. For example, the server environment 110 can be provided as a cloud computing environment.

The components of the server environment 110 can provide annotation services to one or more client devices, such as client device 140, via a connecting network 150 (e.g., a network comprising the Internet). The server environment 110 can provide annotation services such as services for receiving digital documents (e.g., from client devices, such as client device 140), generating document images from the received digital documents, sending document images to client devices, receiving annotation information from client devices, and storing annotation information, document images, and related information in a storage repository 130.

### Example 13

### Exemplary Annotation Environment Components

In any of the examples herein, an annotation environment can be provided for creating, editing, storing, and viewing annotations. The annotation environment can comprise various software and/or hardware components for performing operations related to providing annotation services.

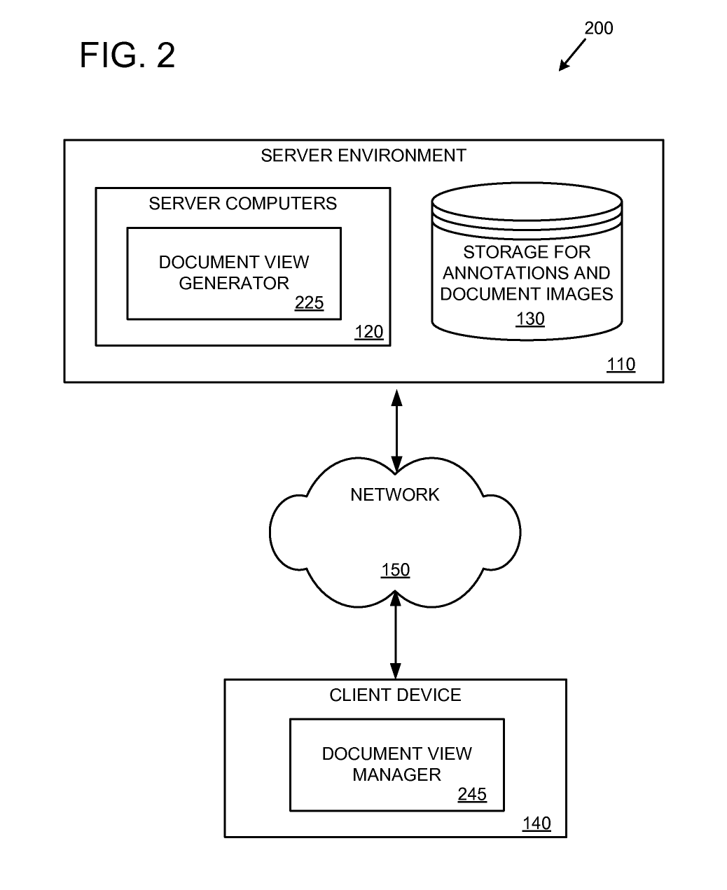

FIG. 2 is a diagram depicting an example annotation environment 200. The example annotation environment 200 includes a server environment 110 that comprises computer servers 120 and storage for annotations and document images 130. For example, the server environment 110 can be provided as a cloud computing environment.

The server computers 120 comprise a document view generator 225. The document view generator 225 comprises software and/or hardware supporting the annotation services provided by the server environment 110. For example, the document view generator 225 can receive digital documents, generate document images from the digital documents, receive and store annotation content, provide annotation content and document images for viewing or editing, and support other annotation-related operations.

The document view generator 225 of the server environment 110 (alone or in combination with other components of the server environment 110) can provide annotation services to one or more client devices, such as client device 140, via a connecting network 150 (e.g., a network comprising the Internet). The document view generator 225 can provide annotation services such as services for receiving digital documents from client devices (e.g., from client device 140), generating document images from the received digital documents, sending document images to client devices (e.g., to client device 140), receiving annotation information from client devices (e.g., from client device 140), and storing annotation information, document images, and related information in a storage repository 130.

The client device 140 can include a document view manager 245. The document view manager 245 comprises software and/or hardware supporting annotation services at the client device 140. For example, the document view manager 245 can send digital documents to the document view generator 225 and receive document images from the document view generator 225. The document view manager 245 can provide an environment for a user to create and edit annotations (e.g., text, audio, video, picture, and other types of annotations) on top of document images received from the document view generator 225 (e.g., on top of document image pages). The document view manager 245 can provide an environment for a user to create annotations in a positional annotation mode and a temporal annotation mode.

The document view manager 245 can display annotations. For example, the document view manager 245 can receive or download document image pages, associated annotation content (e.g., in an annotation format) and/or other associated content (e.g., separate audio or video files) from the document view generator 225 (e.g., retrieved from the storage repository 130). The document view manager 245 can allow a user to view or play the annotation content (e.g., to view annotations displayed on the document image pages, or play a set of document image pages in a temporal annotation mode with annotation elements appearing according to a timeline of an audio or video file according to an annotation format).

### Example 14

### Exemplary Methods for Annotating Documents

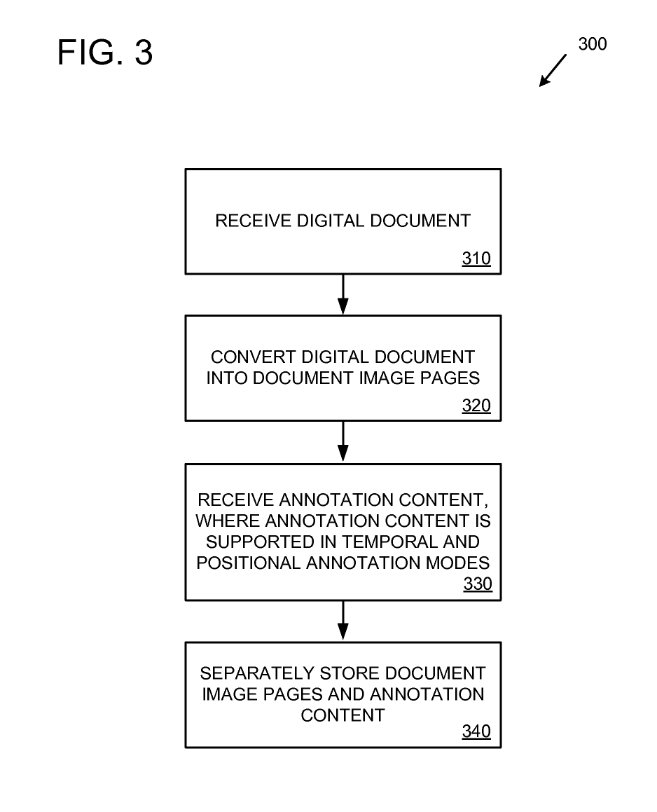

FIG. 3 is a flowchart of an exemplary method 300 for annotating digital documents. At 310, a digital document is received. For example, the digital document can be received by a document view generator (e.g., received by the document view generator 225). The digital document can comprise one or more pages. For example, the digital document can be a 5 page Word document, a 10 page PDF document, or a number of Web pages.

At 320, the received digital document 310 is converted into document image pages. For example, each page of the digital document can be converted (from a document format, such as Word or PDF) into a corresponding document image page. The document image pages are in an image format (e.g., JPEG, PNG, or another image format).

At 330, annotation content is received for the document image pages, where the annotation content is supported in a temporal annotation mode and in a positional annotation mode. The annotation content represents annotations (e.g., annotation elements) such as text annotations, audio annotations, video annotations, picture annotations, and drawing annotations. The annotation content can be in an annotation format that defines the annotation elements (e.g., defines content, placement, and/or timing information for the annotation elements). The annotation content can be received by a server environment from a client device.

At 340, the document image pages and the annotation content are stored separately. For example, the document image pages can be stored as separate document image files (e.g., JPEG or PNG files), and the annotation content can be stored in separate files (e.g., XML files according to an annotation format). Document image pages can be displayed separate from their associated annotation content. For example, if a client device does not contain software capable of displaying the annotation content, the document image pages can still be viewed.

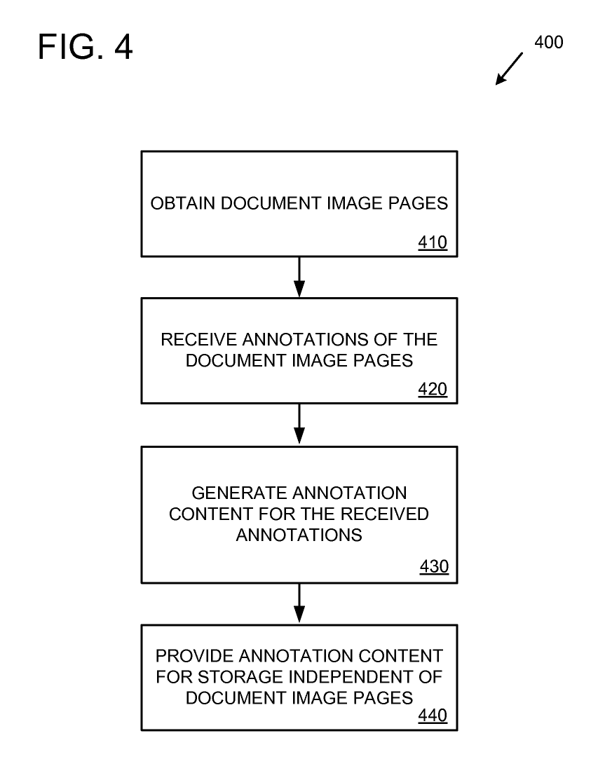

FIG. 4 is a flowchart of an exemplary method 400 for annotating digital documents. At 410, document image pages are obtained. The document image pages correspond to pages of a digital document that have been converted into the document image pages. For example, the document image pages can be received from a local or remote component (e.g., a local or remote document view generator) that converts a digital document into the document image pages.

At 420, annotations of the document image pages are received. The annotations are supported in a temporal annotation mode and in a positional annotation mode. For example, the annotations can be received by a document view manager of a computing device (e.g., from a user entering the annotations using the computing device). The annotations can comprise text annotations, audio annotations, video annotations, picture annotations, drawing annotations, and other types of annotations.

At 430, annotation content is generated from the received annotations 420. For example, if a user creates a text annotation, the annotation content can comprise the text content of the text annotation as well as positional information (e.g., where the text annotation is to be displayed on a document image page) and timing/duration information (e.g., if the annotation is to be displayed at a certain time or for a certain duration). The annotation content can be generated by a document view manager of a computing device.

At 440, the annotation content is provided for storage independent (separately from) the document image pages. For example, the annotation content and the document image pages can be stored in separate files and/or at separate locations. The annotation content and the document image pages can be stored locally or at a remote storage repository.

### Example 15

### Exemplary Positional Annotations

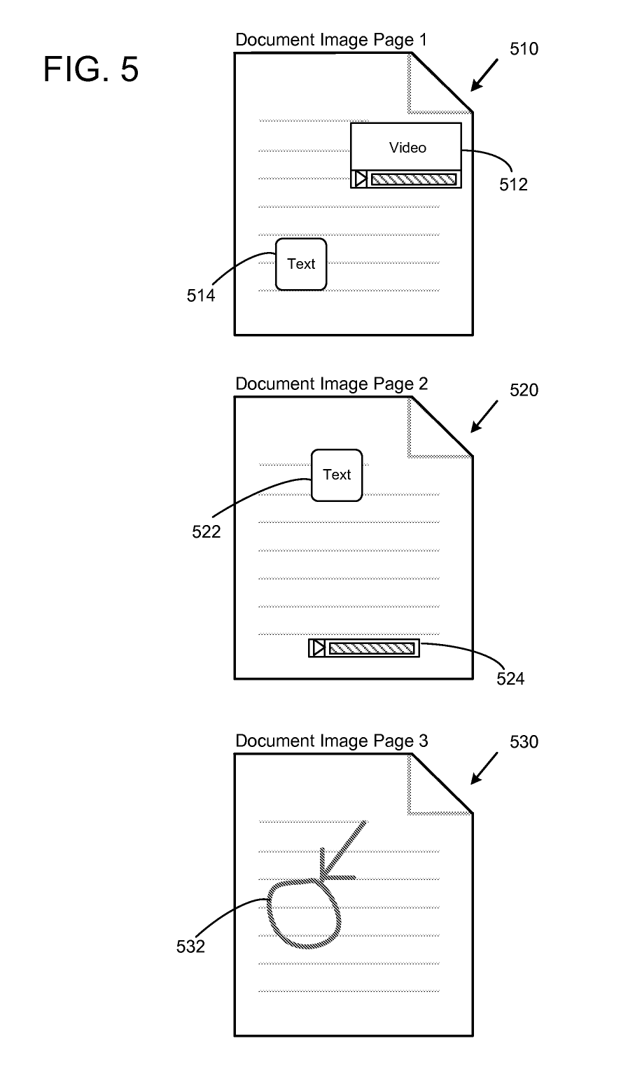

FIG. 5 is a diagram showing example annotation content displayed on top of document image pages using a positional annotation mode. At 510, a first document image page is displayed, “Document Image Page 1,” along with two annotation elements. The first annotation element is a video annotation element 512. The video annotation element 512 is located at a specific position (e.g., at specific coordinates) on the document image page 510 (near the upper-right corner of the document image page 510). A user viewing the document image page 510 can play the video annotation element 512 (e.g., by selecting a “play” button). The second annotation element displayed on the document image page 510 is a text annotation element 514. The text annotation element 514 is displayed at a specific position (e.g., at specific coordinates) on the document image page 510 (near the lower-left corner of the document image page 510).

The position information for the two annotation elements (512 and 514) can be defined using an annotation format that lists specific coordinates for displaying the two annotation elements with reference to the document image page 510.

At 520, a second document image page is displayed, “Document Image Page 2,” along with two annotation elements. The first annotation element is a text annotation element 522. The text annotation element 522 is located at a specific position (e.g., at specific coordinates) on the document image page 520. The second annotation element displayed on the document image page 520 is an audio annotation element 524. The audio annotation element 524 is displayed at a specific position (e.g., at specific coordinates) on the document image page 520. A user viewing the document image page 520 can play the audio annotation element 524 (e.g., by selecting a “play” button).

At 530, a third document image page is displayed, “Document Image Page 3,” along with one annotation element. The one annotation element is a drawing annotation element 532. The drawing annotation element 532 is located at a specific position (e.g., at specific coordinates) on the document image page 530. The drawing annotation element 532 can be displayed as an animated drawing (with the drawing performed over time, as it was originally drawn) or as a static image of the final drawing.

The example document image pages 510, 520, and 530 can be displayed by a user (e.g., using a document view manager). For example, a user can display the first document image page 510 along with its associated annotation content (annotation elements 512 and 514). The user can transition to displaying document image page 520 along with its associated annotation content (annotation elements 522 and 524), and so on.

The document image pages 510, 520, and 530 can be transmitted from a server environment to one or more client devices (e.g., multiple client devices can access, view, create, and/or edit the annotation content for the image pages). Similarly, client devices can request document image pages 510, 520, and 530 from a server environment for use by the client devices.

The document image pages 510, 520, and 530, and associated annotation content, can be provided (or requested) when needed (e.g., on demand). Providing for on-demand delivery of document image pages can provide for efficient network resource utilization. For example, a client device can download just a first document image page and its associated annotation content (e.g., page 510 and annotation elements 512 and 514) and display them on a display of the computing device. When and if a transition is made to the next page (e.g., to page 520), then the next page can be downloaded (e.g., page 520 with annotation elements 522 and 524) and displayed. In this manner, document image pages and associated annotation content are only downloaded when needed, providing for less delay before the content is displayed (e.g., the user may not have to wait for a complete multi-page document to be downloaded) and reduced bandwidth consumption (e.g., if the user only views some of the document image pages of the document).

A server environment can process document image pages (e.g., 510, 520, and 530) according to capabilities of client devices. For example, the resolution of a document image page can be reduced to match the display capabilities of a specific client device (e.g., to match the screen resolution of the client device). Similarly, the resolution of the document image page can be reduced to account for network bandwidth limitations. Other capabilities can also be taken into consideration, such as security capabilities (or security policies) and corporate standards or policies.

Even though the document image pages 510, 520, and 530 use a positional annotation mode, the associated annotation elements can still use temporal information. For example, display of an annotation element can be delayed for a specific amount of time after a page is displayed (e.g., element 522 can be displayed 10 seconds after page 520 is displayed, or audio element 524 can begin playing 5 seconds after page 520 is displayed). Similarly, display of annotation elements can be timed (e.g., only displayed for a specific amount of time and then removed from display).

The document image pages 510, 520, and 530 can be accessed by a user for display and/or editing. For example, the user can view the document image pages and associated annotation content by viewing the first page and its associated annotation content, selecting next to view the second page and its associated annotation content, and selecting next to view the third page and its associated annotation content. The user can also view the document image pages and associated annotation content in an editing environment allowing the user to create, edit, or modify the document image pages and annotation content (e.g., add/edit/delete document image pages and add/edit/delete annotation elements).

### Example 16

### Exemplary Temporal Annotations

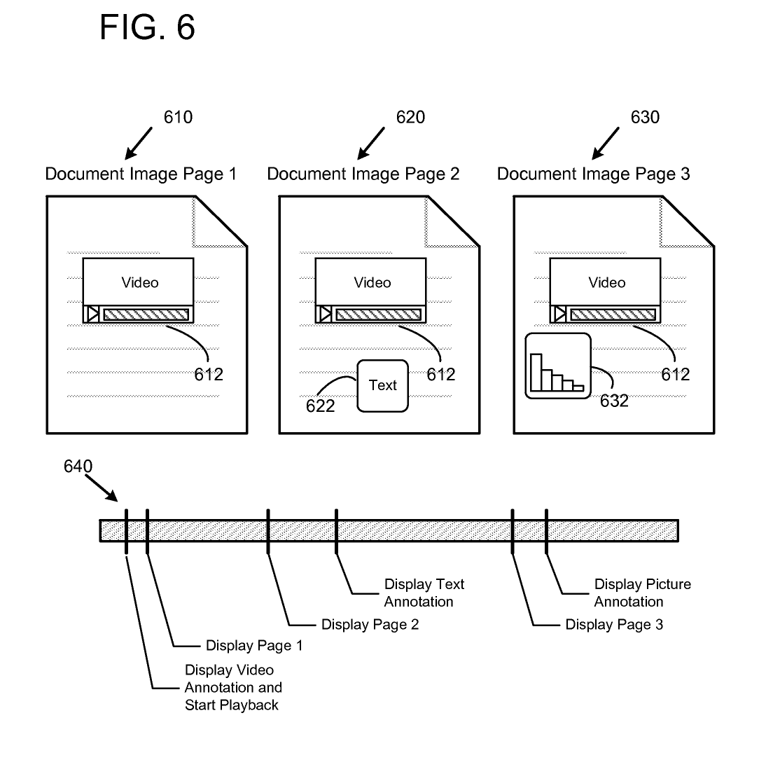

FIG. 6 is a diagram showing example annotation content displayed on top of document image pages using a temporal annotation mode. In the temporal annotation mode, the annotations are based on a timeline 640. Various events can be positioned using the timeline 640.

According to the example timeline 640, the first event that occurs (e.g., when a user downloads and views the set of document image pages) is display of video annotation element 612. For example, video annotation element 612 could be a video that introduces the user to a financial report for a business. Soon after the video annotation element 612 is displayed and starts playing, document image page 610 (“Document Image Page 1”) is displayed.

At some later time, a transition is made to display of document image page 620 (“Document Image Page 2”). The video annotation element 612 continues to play during display of document image page 620 (e.g., the video annotation element 612 could describe the second page of the financial report). During display of document image page 620, a text annotation element 622 is displayed.

At some later time, a transition is made to display of document image page 630 (“Document Image Page 3”). The video annotation element 612 continues to play during display of document image page 630 (e.g., the video annotation element 612 could describe the third page of the financial report). During display of document image page 630, a picture annotation element 632 is displayed (e.g., the picture annotation element could be a graph chart depicting specific financial performance of the business).

As described above with regard to the positional document image pages depicted in FIG. 5, the document image pages 610, 620, and 630 and associated annotation content depicted in FIG. 6 can be transmitted from a server environment to one or more client devices (or requested by the client devices from the server environment). The document image pages 610, 620, and 630, and associated annotation content, can be provided (or requested) when needed (e.g., on demand). A server environment can process document image pages (e.g., 610, 620, and 630) according to capabilities of client devices.

Even though the document image pages 610, 620, and 630 use a temporal annotation mode, the associated annotation elements can still use positional information. For example, the video annotation element 612 can be located at a specific position on the document image pages.

The document image pages 610, 620, and 630 can be accessed by a user for display and/or editing. For example, the user can view or play the document image pages and associated annotation content according to the timeline 640. The user can also view the document image pages and associated annotation content in an editing environment allowing the user to create, edit, or modify the document image pages and annotation content (e.g., add/edit/delete document image pages, add/edit/delete annotation elements, and add/edit/delete timeline events).

### Example 17

### Exemplary Computing Systems

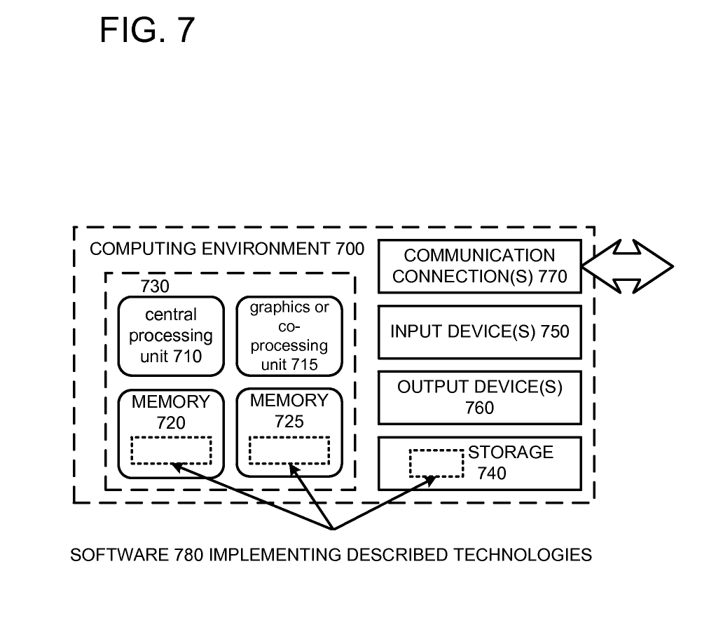

FIG. 7 depicts a generalized example of a suitable computing system 700 in which the described innovations may be implemented. The computing system 700 is not intended to suggest any limitation as to scope of use or functionality, as the innovations may be implemented in diverse general-purpose or special-purpose computing systems.

With reference to FIG. 7, the computing system 700 includes one or more processing units 710, 715 and memory 720, 725. In FIG. 7, this basic configuration 730 is included within a dashed line. The processing units 710, 715 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 7 shows a central processing unit 710 as well as a graphics processing unit or co-processing unit 715. The tangible memory 720, 725 may be volatile memory (e.g., registers, cache, RAM), non-volatile memory (e.g., ROM, EEPROM, flash memory, etc.), or some combination of the two, accessible by the processing unit(s). The memory 720, 725 stores software 780 implementing one or more innovations described herein, in the form of computer-executable instructions suitable for execution by the processing unit(s).

A computing system may have additional features. For example, the computing system 700 includes storage 740, one or more input devices 750, one or more output devices 760, and one or more communication connections 770. An interconnection mechanism (not shown) such as a bus, controller, or network interconnects the components of the computing system 700. Typically, operating system software (not shown) provides an operating environment for other software executing in the computing system 700, and coordinates activities of the components of the computing system 700.

The tangible storage 740 may be removable or non-removable, and includes magnetic disks, magnetic tapes or cassettes, CD-ROMs, DVDs, or any other medium which can be used to store information in a non-transitory way and which can be accessed within the computing system 700. The storage 740 stores instructions for the software 780 implementing one or more innovations described herein.

The input device(s) 750 may be a touch input device such as a keyboard, mouse, pen, or trackball, a voice input device, a scanning device, or another device that provides input to the computing system 700. For video encoding, the input device(s) 750 may be a camera, video card, TV tuner card, or similar device that accepts video input in analog or digital form, or a CD-ROM or CD-RW that reads video samples into the computing system 700. The output device(s) 760 may be a display, printer, speaker, CD-writer, or another device that provides output from the computing system 700.

The communication connection(s) 770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 18

### Exemplary Mobile Device

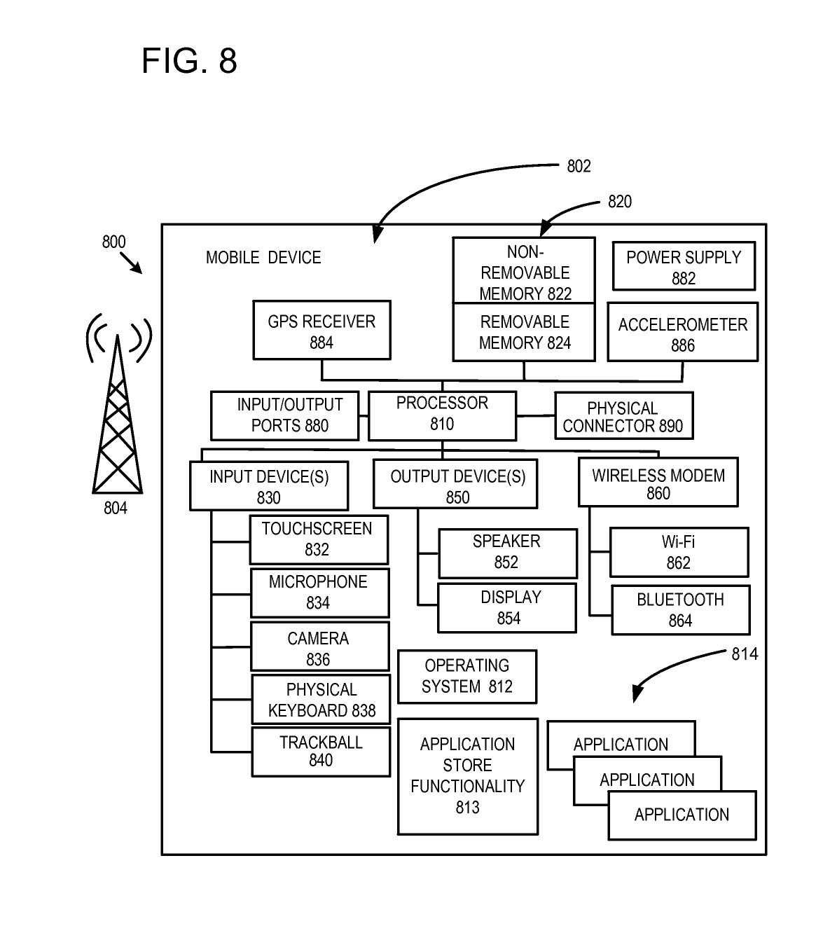

FIG. 8 is a system diagram depicting an exemplary mobile device 800 including a variety of optional hardware and software components, shown generally at 802. Any components 802 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 804, such as a cellular, satellite, or other network.

The illustrated mobile device 800 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components 802 and support for one or more application programs 814. The application programs can include common mobile computing applications (e.g., email applications, calendars, contact managers, web browsers, messaging applications), or any other computing application. Functionality 813 for accessing an application store can also be used for acquiring and updating applications 814.

The illustrated mobile device 800 can include memory 820. Memory 820 can include non-removable memory 822 and/or removable memory 824. The non-removable memory 822 can include RAM, ROM, flash memory, a hard disk, or other well-known memory storage technologies. The removable memory 824 can include flash memory or a Subscriber Identity Module (SIM) card, which is well known in GSM communication systems, or other well-known memory storage technologies, such as “smart cards.” The memory 820 can be used for storing data and/or code for running the operating system 812 and the applications 814. Example data can include web pages, text, images, sound files, video data, or other data sets to be sent to and/or received from one or more network servers or other devices via one or more wired or wireless networks. The memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 800 can support one or more input devices 830, such as a touch screen 832, microphone 834, camera 836, physical keyboard 838 and/or trackball 840 and one or more output devices 850, such as a speaker 852 and a display 854. Other possible output devices (not shown) can include piezoelectric or other haptic output devices. Some devices can serve more than one input/output function. For example, touchscreen 832 and display 854 can be combined in a single input/output device.

A wireless modem 860 can be coupled to an antenna (not shown) and can support two-way communications between the processor 810 and external devices, as is well understood in the art. The modem 860 is shown generically and can include a cellular modem for communicating with the mobile communication network 804 and/or other radio-based modems (e.g., Bluetooth 864 or Wi-Fi 862). The wireless modem 860 is typically configured for communication with one or more cellular networks, such as a GSM network for data and voice communications within a single cellular network, between cellular networks, or between the mobile device and a public switched telephone network (PSTN).

The mobile device can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components 802 are not required or all-inclusive, as any components can deleted and other components can be added.

### Example 19

### Exemplary Cloud Computing Environment

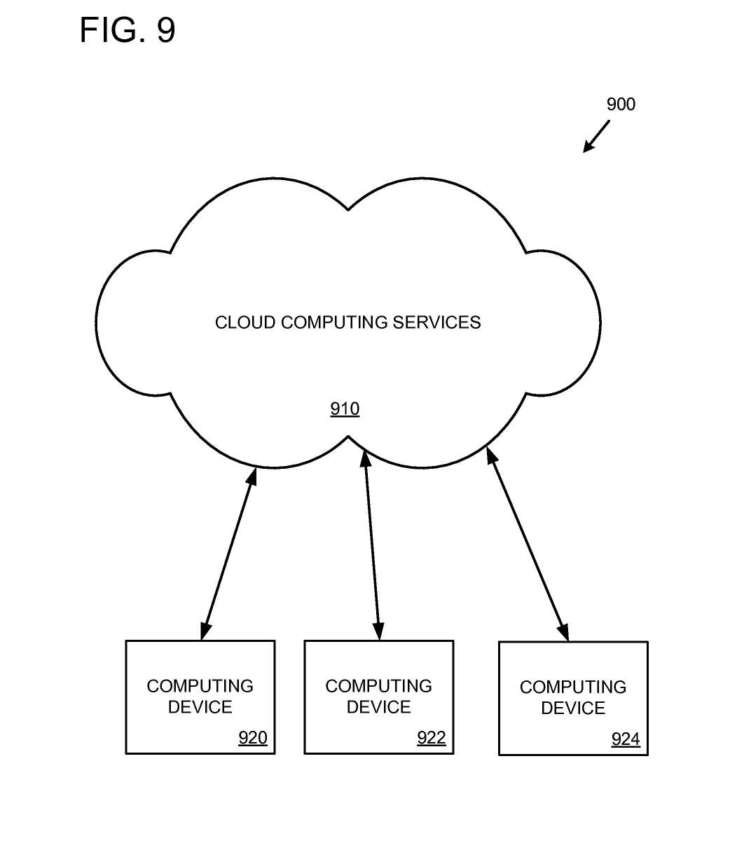

FIG. 9 depicts an example cloud computing environment 900 in which the described technologies can be implemented. The cloud computing environment 900 comprises cloud computing services 910. The cloud computing services 910 can comprise various types of cloud computing resources, such as computer servers, data storage repositories, networking resources, etc. The cloud computing services 910 can be centrally located (e.g., provided by a data center of a business or organization) or distributed (e.g., provided by various computing resources located at different locations, such as different data centers and/or located in different cities or countries).

The cloud computing services 910 are utilized by various types of computing devices (e.g., client computing devices), such as computing devices 920, 922, and 924. For example, the computing devices (e.g., 920, 922, and 924) can be computers (e.g., desktop or laptop computers), mobile devices (e.g., tablet computers or smart phones), or other types of computing devices. For example, the computing devices (e.g., 920, 922, and 924) can utilize the cloud computing services 910 to perform computing operators (e.g., data processing, data storage, and the like).

### Example 20

### Exemplary Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., non-transitory computer-readable media, such as one or more optical media discs such as DVD or CD, volatile memory components (such as DRAM or SRAM), or nonvolatile memory components (such as flash memory or hard drives)). By way of example and with reference to FIG. 7, computer-readable storage media include memory 720 and 725 and storage 740. By way of example and with reference to FIG. 8, computer-readable storage media include memory and storage 820, 822, and 824. As should be readily understood, the term computer-readable storage media does not include communication connections (e.g., 770, 860, 862, and 864) such as modulated data signals.

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

### ALTERNATIVES

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

We claim:

1. A method, implemented at least in part by one or more computing devices, for annotating digital documents, the method comprising:
by the one or more computing devices:
receiving a digital document;
converting pages of the received digital document into corresponding document image pages;
receiving annotation content for the document images, wherein the annotation content is supported in a temporal annotation mode and in a positional annotation mode; and
storing the document image pages and the annotation content, wherein the document image pages and the annotation content are stored separately, and wherein the document image pages are available for display separately from the annotation content.

2. The method of claim 1 further comprising:
processing the document image pages according to device capabilities of a client device; and
sending, to the client device, the processed document image pages;
wherein a user of the client device creates annotations on top of the processed image pages, wherein the annotation content is generated at the client device from the annotations, wherein the annotation content is received from the client device by the one or more computing devices, and wherein the one or more computing devices are part of a server environment.

3. The method of claim 1 further comprising:
providing, to a client device, the document image pages and the annotation content for display at the client device, wherein the document image pages and the annotation content are provided for display according to at least one of the temporal annotation mode and the positional annotation mode.

4. The method of claim 1 wherein the digital document is divided into a plurality of pages, wherein each page of the digital document is converted, from a document format, into a corresponding document image page in an image format, and wherein the annotation content is segmented by document image page, the method further comprising:
receiving, from a client device, a request for a first document image page;
responsive to the request for the first document image page, sending, to the client device, the first document image page and a segment of the annotation content corresponding to the first document image page;
receiving, from a client device, a request for a second document image page; and
responsive to the request for the second document image page, sending, to the client device, the second document image page and a segment of the annotation content corresponding to the second document image page.

5. The method of claim 1 wherein the annotation content is defined using the positional annotation mode, and wherein the annotation content comprises positional information, relative to the document image pages, for one or more annotation elements.

6. The method of claim 1 wherein the annotation content is defined using the temporal annotation mode, and wherein the temporal annotation mode specifies at least one of an audio file and a video file as providing a timeline for the annotation content.

7. The method of claim 1 wherein the annotation content comprises dynamic annotation content, wherein the dynamic annotation content supports timing information comprising a start time and a duration for annotation elements.

8. The method of claim 1 wherein the annotation content comprises text annotation elements, audio annotation elements, video annotation elements, and drawing annotation elements.

9. The method of claim 1 wherein the annotation content is defined using an annotation format, wherein the annotation format comprises:
an annotation mode, wherein the annotation mode is one of a temporal annotation mode and a positional annotation mode; and
for each of the document image pages:
a unique page identifier of the document image page;
annotation elements associated with the document image page; and
events associated with the document image page.

10. A method, implemented at least in part by a computing device, for annotating digital documents, the method comprising:
by the computing device:
obtaining a plurality of document image pages, wherein the plurality of document image pages correspond to pages of a digital document that have been converted into the plurality of document image pages;
receiving, from a user of the computing device, annotations of the plurality of document image pages, wherein the annotations are supported in a temporal annotation mode and in a positional annotation mode;
generating annotation content from the received annotations; and
providing the annotation content for storage, wherein the annotation content is stored independent of the document image pages, and wherein the document image pages are available for display separately from the annotation content.

11. The method of claim 10 wherein the obtaining the plurality of document image pages comprises:
sending, to one or more computer servers, the digital document, wherein the pages of the digital document are converted by the one or more computer servers into the plurality of document image pages; and
receiving, from the one or more computer servers, the plurality of document image pages.

12. The method of claim 10 wherein the providing the annotation content for storage comprises:
sending, to one or more computer servers, the annotation content, wherein the annotation content is stored by the one or more computer servers independent of the document image pages;
wherein the annotation content and the document image pages are available, from the one or more computer servers, for display and modification by a plurality of client computing devices; and
wherein the one or more computer servers support sharing, among the plurality of client computing devices, of the annotation content and the document image pages, including additional or modified annotation content created by the plurality of client computing devices and stored by the one or more computer servers.

13. The method of claim 10 wherein the document image pages and the annotation content is stored by one or more computer servers, the method further comprising:
sending, to the one or more computer servers, a request for a first document image page;
responsive to the request for the first document image page, receiving, from the one or more computer servers, the first document image page and a segment of the annotation content corresponding to the first document image page;
sending, to the one or more computer servers, a request for a second document image page; and
responsive to the request for the second document image page, receiving, from the one or more computer servers, the second document image page and a segment of the annotation content corresponding to the second document image page.

14. The method of claim 10 wherein the annotation content is defined using the positional annotation mode, and wherein the annotation content comprises positional information, relative to the document image pages, for one or more annotation elements.

15. The method of claim 10 wherein the annotation content is defined using the temporal annotation mode, and wherein the temporal annotation mode specifies at least one of an audio file and a video file as providing a timeline for the annotation content.

16. The method of claim 10 wherein the annotation content comprises dynamic annotation content, wherein the dynamic annotation content supports timing information comprising a start time and a duration for annotation elements.

17. The method of claim 10 wherein the annotation content comprises text annotation elements, audio annotation elements, video annotation elements, and drawing annotation elements.

18. The method of claim 10 wherein the annotation content is defined using an annotation format, wherein the annotation format comprises:
an annotation mode, wherein the annotation mode is one of a temporal annotation mode and a positional annotation mode; and
for each of the document image pages:
a unique page identifier of the document image page;
annotation elements associated with the document image page; and
events associated with the document image page.

19. A system comprising:
one or more processing units;
memory;
one or more computer-readable storage media storing computer-executable instructions for causing the system to perform operations comprising:
obtaining a plurality of document image pages, wherein the plurality of document image pages correspond to pages of a digital document that have been converted into the plurality of document image pages;
receiving, from a user of the system, annotations of the plurality of document image pages, wherein the annotations are supported in a temporal annotation mode and in a positional annotation mode;
generating annotation content from the received annotations, wherein the annotation content comprises text annotation elements, audio annotation elements, video annotation elements, and drawing annotation elements; and
providing the annotation content for storage, wherein the annotation content is stored independent of the document image pages, and wherein the document image pages are available for display separately from the annotation content.

20. The system of claim 19 wherein the annotation content is defined using an annotation format, wherein the annotation format comprises:
an annotation mode, wherein the annotation mode is one of a temporal annotation mode and a positional annotation mode; and
for each of the document image pages:
a unique page identifier of the document image page;
annotation elements associated with the document image page; and
events associated with the document image page.
